(19) United States
(12) Patent Application Publication
(10) Pub. No.: US 2008/0244646 A1
(43) Pub. Date: Oct. 2, 2008

(54) Channel Switching Device and Channel Switching Method

(75) Inventor: Masayoshi Son, Minato-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SOFTBANK BB CORP., Tokyo (JP)

(21) Appl. No.: 11/570,597

(22) PCT Filed: Jun. 17, 2005
(86) PCT No.: PCT/JP05/11172

§ 371 Date: Sep. 21, 2007

(30) Foreign Application Priority Data
Jun. 18, 2004 (JP) 2004-181560

(51) Int. Cl. H04N 5/445; H04N 7/173

(52) U.S. Cl. 725/38

(57) ABSTRACT

A set top box 41 having a content acquisition unit 411 for receiving a content or reading out a content accumulated acquires a switching request signal and a skip request signal based on the user operation and switches the channel identifying the content received or read out at the content acquisition unit according to the switching request signal. When switching the channel, the channel is switched in the order of the channel number according to the switching request signal. When the channel number is displayed and a skip request signal is acquired, the channel is switched in the order of the group name based on the attribute information correlated with the content and the channel. Thus, it is possible to realize the zapping operation for selecting a desired content from a plenty of contents by a simple user interface and operation.

### TECHNICAL FIELD

The present invention relates to a channel switching device and a channel switching method for a receiver or the like capable of displaying and outputting internet delivery content which is delivered from a ground wave broadcast, a satellite broadcast, a cable television broadcast, VOD (Video On Demand) or the like.

### BACKGROUND ART

In the past, when viewing and listening a television or the like, unless there is no particular channel or program which the viewer wants to view and listen, he performs the so-called zapping in which the most interesting program is selected after switching the channel in rotation by the use of a remote control or the like while viewing the programs of the respective channels for a while in turn.

Meanwhile, in recent years, CS broadcasts become available in addition to ground wave broadcasts and BS broadcasts, as well as cable televisions which have been widely distributed and VOD content delivery services which have been provided through the Internet, such that the number of channels increases. As the number of channels increases, the zapping operation as discussed above becomes difficult.

In this regard, techniques have been proposed for supporting viewers who are making selection of favorite programs by making it easy to select a program (for example, refer to Japanese Patent Published Application No. Tokukai 2002-335459).

In accordance with the technique as disclosed in this document, program information about program content are stored in a storage unit, and searched on the basis of a search keyword which is input by user's manipulation such as moving a cursor on the screen and so forth, such that the content or information of the program as a search result is sequentially switched and displayed to the user as a zapping operation.

However, in the case of the technique disclosed in the document as discussed above, a search keyword has to be input on the screen and thereby the manipulation is cumbersome. Particularly, because delicate motion such as moving or clicking a cursor is required, it takes much time to perform the required operation by manipulating a remote control, and there is a problem in that the manipulation is too complicated for the elderly.

### DISCLOSURE OF THE INVENTION

Taking into consideration the above circumstances, it is an object of the present invention to provide a channel switching device and a channel switching method for enabling the zapping operation through a simple user interface and manipulation for selecting a desired item of content from among a number of items of content.

In order to accomplish the object as described above, the present invention comprises a content acquisition unit operable to receive content, or to read content from a content accumulation unit which accumulates the content as received, wherein a switching request signal and a skip request signal are acquired on the basis of user's manipulation, and the channels which specify the content to be received or read are switched in response to the switching request signal.

Particularly, when switching the channel, the channel is switched in the order of the character strings describing the channels in response to the switching request signal, while displaying the character strings describing the channels in synchronization with the switching of the channel, and when the skip request signal is acquired, the channel switching is changed on a group-to-group basis in accordance with attribute information associated with the content or the channels such that the channel is successively switched in the order of character strings describing groups.

In accordance with the present invention as described above, it is possible to select between switching among the groups or switching the channel in the order of the channel numbers on the basis of the arbitrary manipulation, and therefore quickly access a favorite program.

In accordance with the above invention, it is preferred that the skip request signal is a switching request signal which is continuously acquired for a predetermined period or longer. In this case, for example, it is possible to simplify the manipulation by continuing pressing the channel switch key of a remote control to continuously output the switching request signal so that the normal switching is automatically changed to the skipping switching.

In accordance with the above invention, it is preferred that when the output of the skip request signal is halted during displaying the character string indicative of a group, the channel is switched to represent the group which is displayed. In this case, it is possible to immediately recognize the group, which is reached when the output of the skip request signal is halted, by making use of the representative channel thereof as the channel to be displayed for the meantime.

In accordance with the above invention, in the case where the acquisition of the skip request signal is halted when the character string describing a group is being displayed, if the switching request signal is acquired within a predetermined period after halting the acquisition, switching operation is successively performed among the channels belonging to the group, which is displayed, in the order of the character strings describing the channels.

In this case, it is possible to successively switch the channel only within a particular group just after the zapping operation through the groups, i.e., to narrow the selection after rough selection, and therefore the channel switching can be more quickly performed.

In accordance with the above invention, the channel display unit displays the content of the channel which is switched or the content relating to the group which is switched. In this case, it is possible to display, for example, a motion picture and a still image which compactly indicate the content of the group, and recognize a group during the skipping operation in an appropriate manner.

### BRIEF DESCRIPTION OF THE DRAWINGS

FIG. 1 a view for schematically showing the configuration of a VOD system in accordance with an embodiment.

FIG. 2 is a block diagram for showing the internal configuration of a set top box in accordance with the embodiment.

FIG. 3 is an explanatory view for showing the grouping of channels in accordance with the embodiment.

FIG. 4 is a flow chart for showing the operation of the VOD system in accordance with the embodiment.

### BEST MODE FOR CARRYING OUT THE INVENTION

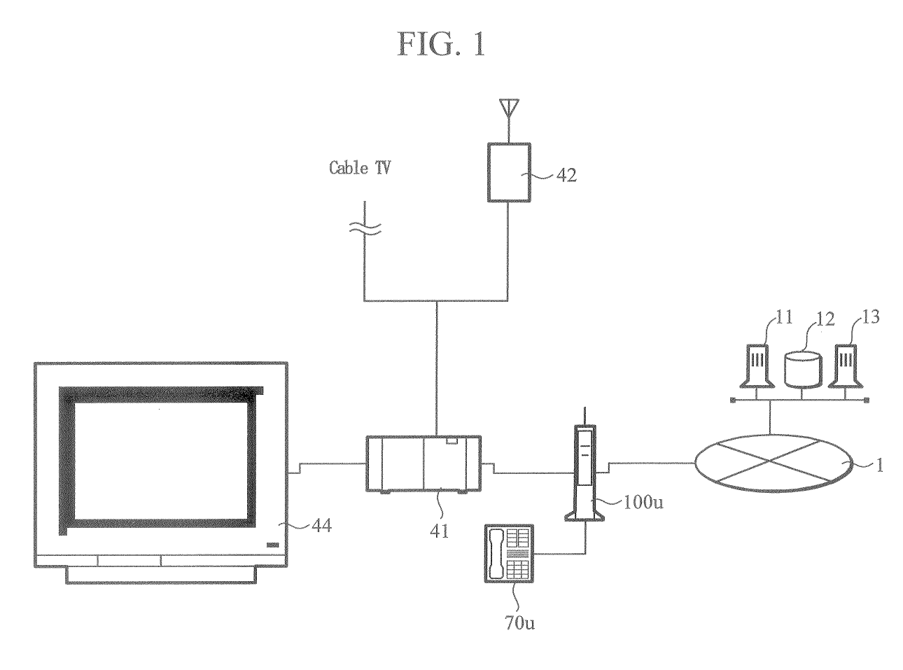

An embodiment of the present invention will be explained with reference to the accompanying drawings. In the present embodiment, the channel switching device in accordance with the present invention will be explained as an example applied for a VOD system. FIG. 1 a view for schematically showing the configuration of the VOD system in accordance with the present embodiment.

(Overall Configuration of the VOD System)

As illustrated in FIG. 1 the VOD system is a system placed in the user's home, and provided with a terminal equipment 100u connected to an IP network 1, a set top box 41 for receiving broadcast programs and the like, and a monitor device 44 for displaying the moving picture which is received through the set top box 41.

The IP network 1 is a distributed communication network which is constructed by connecting a variety of communication lines (a public network such as a telephone line, an ISDN line, an ADSL line or an optical line, a dedicated communication line, and a radio communication network) to each other by the use of the communication protocol TCP/IP. This IP network 1 may be a LAN such as an intranet (a network within a company) based on 10BASE-T, 100BASE-TX or the like. In the present embodiment, there are a content delivery server 11, a content database server 12 and a delivery management server 13 located on this IP network 1.

The content delivery server 11 is a document system of the WWW (World Wide Web) or the like, and is implemented as a server computer or software capable of performing the streaming delivery of motion pictures by the VOD system, and in addition to this, transmitting content such as HTML (HyperText Markup Language) files, image files, music files and the like, and serves to deliver content data accumulated in the content database server 12 through the IP network 1 in response to that request from the set top box 41.

The delivery management server 13 is a server unit which collects the information about the program content, time schedule, broadcast channels, data addresses and the like of cable TV broadcasts, ground wave broadcasts, satellite broadcasts and the content delivery from the above content delivery server 11, generates attribute information associated with the content and channels, and transmit the attribute information as generated to the set top box 41.

The terminal equipment 100u is an equipment for connecting a terminal device such as a personal computer or an IP telephone terminal with the IP network 1, and serves to perform modulation and demodulation for conversion between digital data and voice signals when connecting with a telephone line and signal conversion between ADSL signals and LAN signals when connecting with an ADSL line. In addition, this terminal equipment 100u is provided with VOIP capability of performing conversion between voice signals and IP packets, and a telephone terminal 70u connected to this can be used for IP telephone.

The monitor devices 44 may be a television receiver, the monitor of a personal computer or the like, and serves to output the content received and accumulated in the set top box 41.

The set top box 41 is a device serving to receive the content broadcasted as ground waves or satellite broadcast waves through a reception antenna 42 and the content delivered from a cable television station and delivered through the IP network 1, accumulate the content and selectively outputs the content to the monitor device 44.

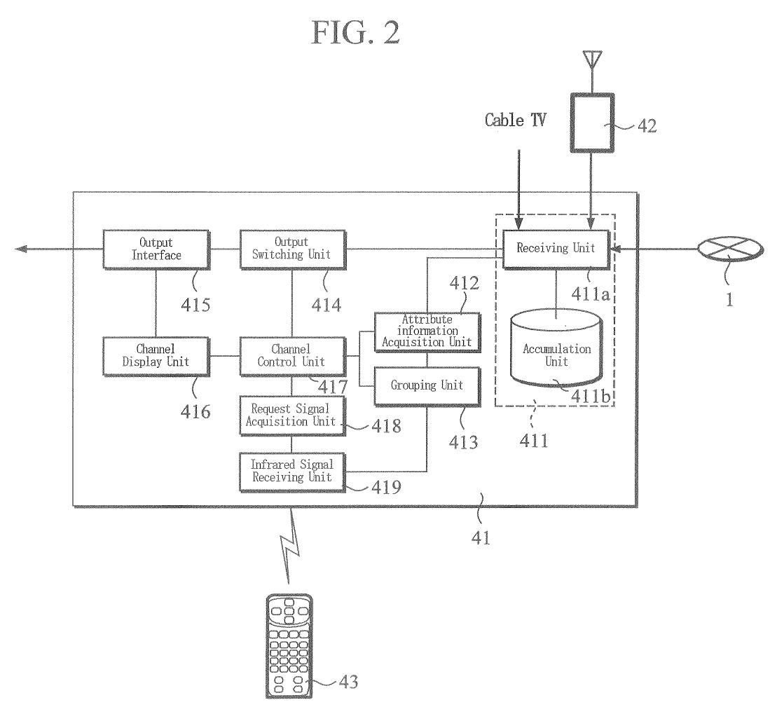

FIG. 2 is a block diagram or showing the internal configuration of the set top box 41. Namely, this set top box 41 is provided with a content acquisition unit 411 for receiving content, and if appropriate, accumulating the content as received.

The content acquisition unit 411 in accordance with the present embodiment is composed of a receiving unit 411a for receiving content from the cable television, the reception antenna 42 or the IP network 1, and an accumulation unit 411b for accumulating the content as received by the receiving unit 411a, and transmits the content as received by the receiving unit 411a or the content as read from the accumulation unit 411b to an output switching unit 414. In addition, the receiving unit 411a receives channel attribute information which is delivered from the delivery management server 13 on the IP network 1, and is provided with the capability of outputting the channel attribute information as received to an attribute information acquisition unit 412.

The output switching unit 414 is a module for transmitting the content as received by the receiving unit 411a or the content as read from the accumulation unit 411b to an output interface 415 under the control of a channel control unit 417.

Incidentally, the term “channel” is used to represent the channel for receiving the content broadcasted from a around wave station, a satellite broadcast station or the cable television station or the like and in addition to this, used to represent a URL, an address or a file name for identifying the content to be downloaded from the IP network 1 in accordance with VOD or the like, and furthermore used to represent the file name of content downloaded and accumulated in the accumulation unit 411b, and so forth.

The output interface 415 is a module which is connected to the monitor device 44 for outputting pictures and sounds. Meanwhile, it is possible to provide this output interface 415 with a temporary storage device or the like for adjusting output pictures.

The set top box 41 is a module for performing channel switching and provided with the channel control unit 417, a request signal acquisition unit 418, a channel display unit 416, an infrared signal receiving unit 419, the attribute information acquisition unit 412 and a grouping unit 413.

The request signal acquisition unit 418 is a module for acquiring a switching request signal and a skip request signal through the infrared signal receiving unit 419 on the basis of the user's manipulation through a remote control 43 or the like. In the case of the present embodiment, the skip request signal is a switching request signal which is continuously acquired for a predetermined period or longer, and the request signal acquisition unit 418 measures the amount of time in which the switching request signal is continuously received and determines that there is a skip request signal if it is received for the predetermined period or longer. The infrared signal receiving unit 419 is a sensor for receiving the switching request signal and the skip request signal emitted from the remote control 43. The signal as received is transmitted to the request signal acquisition unit 418. Incidentally for example, a radio receiver can be used in place of this infrared signal receiving unit.

The channel display unit 416 is a module for displaying a character string (a channel number or a file name) indicative of the channel after the channel control unit 417 switches the channel when operating in a normal mode, and for displaying a genre name to which the channel belongs or the zapping display data when operating in a skipping mode.

The channel control unit 417 is a module for switching the channel which is received by or read from the above content acquisition unit 411 in accordance with the switching request signal. Usually, this channel control unit 417 switches the channel in accordance with the switching request signal in the order of the character string (channel number or content name) indicative of the channel, and displays the current channel name in the channel display unit 416.

In addition, when the request signal acquisition unit 418 acquires the skip request signal the channel control unit 417 sequentially displays the character string indicative of a group in the channel display unit 416. Meanwhile, in the case of the present embodiment, the character string indicative of a group is a genre name which compactly shows the program content. Incidentally, in the case where the genre name is displayed, while the channel is switched by skipping through the representative channels of the respective genres, and the program of each representative channel during skipping is displayed.

On the other hand, in the case of the present embodiment, during the skipping process, there is the capability of providing an accelerated mode for halting the operation of switching the channel by the channel control unit 417 and performing the operation of switching only the genre name which is displayed by the channel display unit 416. Since the time required for reading operation by the output switching unit 414 can be omitted in this accelerated mode, it is possible to accelerate the channel switching operation. Then, in this accelerated mode, when the output of the skip request signal (that is, the switching request signal which is continuously received) is halted during displaying the genre name, the switching operation by the channel control unit 417 is started.

Furthermore, in the accelerated mode, it is possible to display zapping display data relating to the content or genre of the channel by the channel display unit 416. This zapping display data includes pictures and sounds through which the genre can be visually recognized, and is delivered from the delivery management server 13 and stored in the set top box 41. In this case, since the program content can be visually and aurally recognized while omitting the time required for reading operation by the output switching unit 414, it is possible to accelerate the channel switching operation without inhibiting the user-friendliness.

Furthermore, in the case where the acquisition of the skip request signal is halted while displaying the genre name, if the switching request signal is acquired within a predetermined period after halting the acquisition, the channel control unit 417 successively switches among the channels belonging to the displayed genre in the order of the channel name.

The attribute information acquisition unit 412 is a module for acquiring, from the delivery management server 13, an attribute table in which are described the genre names and keywords of the programs (channel and content) which are broadcasted and delivered from the respective media. The content of this attribute table includes, for example, the information as listed in Table 1.

TABLE 1

| Media | Channel or Address | Broadcast Time | Genre | Keyword |
|---|---|---|---|---|
| Ground | CH1 | 18:00-18:30 | Sports | Baseball, Soccer, . . . |
| Wave | | | | |
| Ground | CH2 | 18:00-18:30 | News | Politics, Stock Price, . . . |
| Wave | | | | |
| Ground | CH3 | 18:00-18:30 | Variety | Entertainer A, . . . |
| Wave | | | | |
| BS | BS1 | 18:00-18:30 | Education | English, . . . |
| BS | BS2 | 18:00-18:30 | News | Politics, Stock Price, . . . |
| CATV | CIII | 18:00-18:30 | Movies | Actor B, . . . |
| BB | http://xxxxx.xxxx/xxx1 | | Dramas | Actress C, . . . |
| BB | http://xxxxx.xxxx/xxx2 | | Sports | Player D, . . . |
| BB | http://xxxxx.xxxx/xxx3 | | News | politics, Stock Price, . . . |

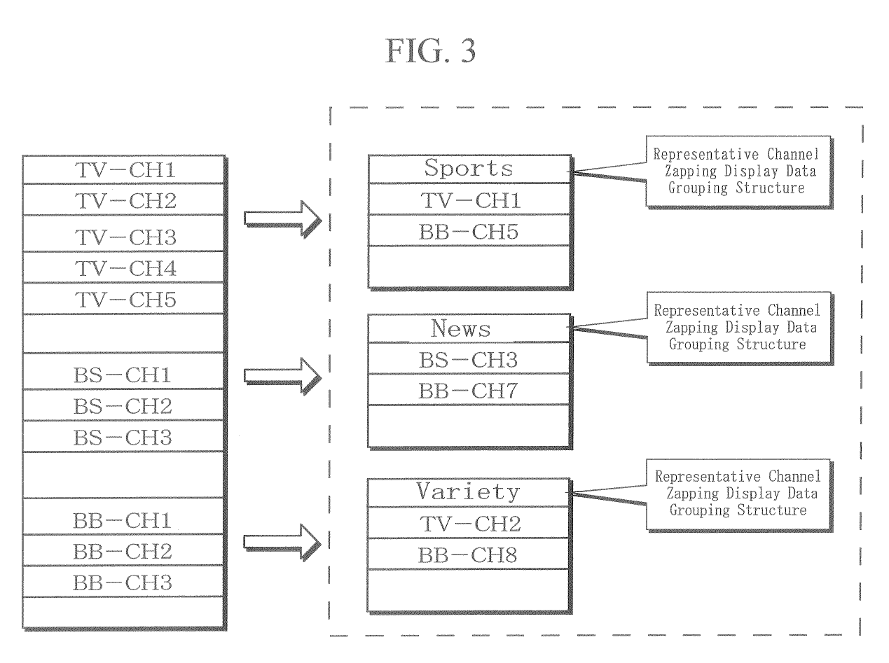

As shown in FIG. 3, the grouping unit 413 divides the channels and content into groups on the basis of the attribute table containing the attribute information associated with the respective programs, performs sorting in the order of the program names (channel number or content name), and determines a representative channel. The channel control unit 417 is notified of this grouping in order to perform channel switching in accordance with the grouping during the skipping process. Incidentally, the respective groups can be associated with the zapping display data.

The settings of the grouping and sorting, the determination of representative channels, the character strings indicative of group names and the zapping display data can be performed by this grouping unit 413 in accordance with the user's manipulation through the remote control 43. In other words, the user can set the grouping and sorting and the condition of representative channels by the use of keywords and the like.

(Operation of the VOD System)

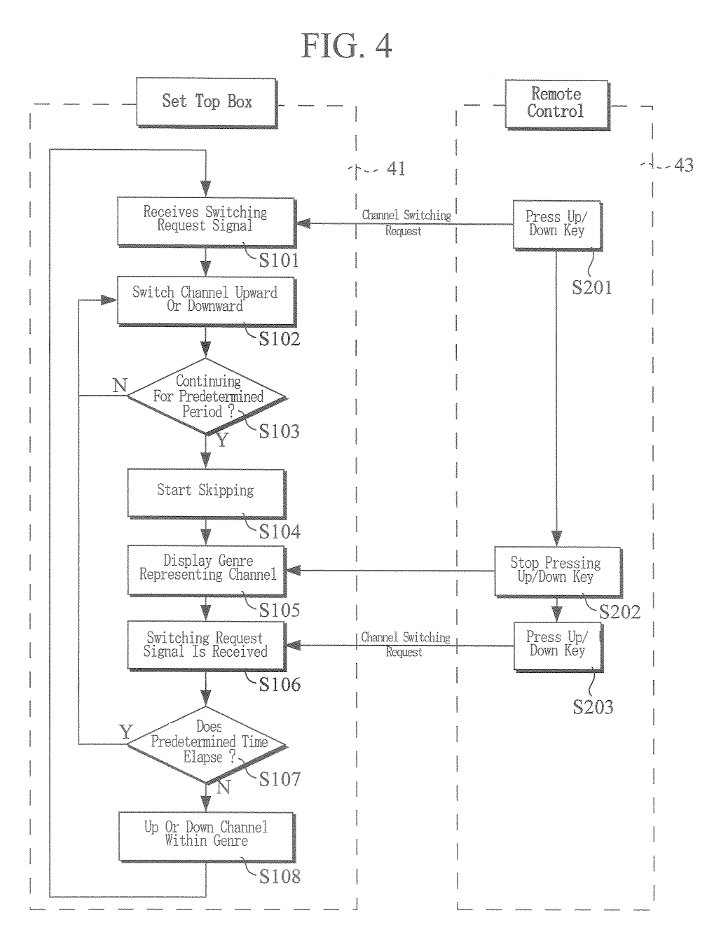

The channel switching method can be performed by operating the VOD system having the structure as described above. FIG. 4 is a flow chart for showing the operation of the VOD system in accordance with the present embodiment.

First of all, when the user presses a channel switch key of the remote control 43 in step S201, the channel switching request signal emitted from the remote control 43 is acquired by the request signal acquisition unit 418 through the infrared signal receiving unit 419 in step S101. In response to this switching request signal, the channel control unit 417 switches the channel upward or downward in the order of the channel numbers in step S102.

Next, the request signal acquisition unit 418 determines the duration of the switching request signal in step S103. When it is determined that the switching request signal is not continuously received for the predetermined period or longer (“N” in step S103), for example, in the case where the user quickly and repeatedly presses and releases the channel switch key, the process is returned to step S101 in which the channel is switched upward or downward in the order of the channel numbers.

On the other hand, when it is determined that the switching request signal is continuously received for the predetermined period or longer (“Y” in step S103) and therefore that the skip request signal is received, the skipping process is started in step S104) in order to switch the representative channel by skipping through the genres in accordance with the grouping by the grouping unit 413. Meanwhile, when the acceleration mode is set during the skipping process, the operation of switching the channel by the channel control unit 417 is halted, and then only the channel number or the zapping display data is displayed.

Then, if pressing the key of the remote control 43 is halted (receiving the switching request signal is stopped) during the skipping process the channel representing the genre at that point is displayed in steps S202 and S105. In this case, measuring the elapsed time after displaying the representative channel is started.

Thereafter, if the switching request signal is received again from the remote control 43 in steps S203 and S106, it is determined whether or not the elapsed time after displaying the representative channel is equal to or longer than a predetermined period in step S107. If the elapsed time is equal to or longer than the predetermined period (“Y” in step 107), the normal channel switching is determined followed by performing the process from step S102. On the other hand, if it is determined that the elapsed time is not longer than the predetermined period (“N” in step S107) and therefore that the skipping process is continued, the channel is switched within the current genre in step S108.

(Modification Example)

While the skip request signal is transmitted and received in response to the switching signal which is continuously outputting in the case of the above embodiment, it is possible to provide the remote control with a dedicated key for skipping operation, and select between the normal switching and the skipping switching by pressing either one of the keys.

### Operation and Effects in Accordance With the Present Embodiment

As has been discussed above, the channel switching device and method in accordance with the present invention makes it possible to select between switching among the groups or switching the channel in the order of the channel numbers on the basis of the arbitrary manipulation, and therefore quickly access a favorite program.

Also, in the case of the present embodiment, since the skip request signal is the switching request signal which is continuously acquired for a predetermined period, it is possible to simplify the manipulation by continuing pressing the channel switch key of the remote control to continuously output the switching request signal so that the normal switching is automatically changed to the skipping switching.

Furthermore, in the case of the present embodiment, it is possible to immediately determine the group, which is reached when the output of the skip request signal is halted, by making use of the representative channel thereof as the channel which is displayed for the meantime. Meanwhile, since this representative channel can be set by the delivery management server 13, it is possible to call attention to the program which is recommended on the delivery side.

Also, in the case of the present embodiment, when the switching request signal is acquired within a predetermined period after halting the skipping operation, since the channel is switched among the channels belonging to the displayed genre in the order of the channel name, it is possible to successively switch the channel only within a particular genre just after the zapping operation through the genres, i.e., to narrow the selection after rough selection, and therefore the channel switching can be more quickly performed.

Furthermore, in the case of the present embodiment, since the channel display unit 416 displays the zapping display data relating to the genre, it is possible to recognize the genre during the skipping operation in an appropriate manner.

### INDUSTRIAL APPLICABILITY

As has been discussed above, in accordance with the present invention, since channel switching and skipping can be performed in accordance with the order and continuity of the switching request signal and the skipping signal for switching the channel, it is possible to perform the zapping operation through a simple user interface and manipulation.

What is claimed is:

1. A channel switching device comprising:
a content acquisition unit operable to receive content, or to read content from a content accumulation unit which accumulates the content as received;
a request acquisition unit operable to acquire a switching request signal and a skip request signal on the basis of user's manipulation;
a channel control unit operable to switch among the channels which specify the content to be received or read by said content acquisition unit in response to said switching request signal;
a channel grouping unit operable to group said channels on the basis of attribute information associated with said channels; and
a channel display unit operable to display a character string describing the channels which is switched in accordance with the switching operation by said channel control unit, or a character string describing said group to which the channel belongs,
wherein the channel is switched by said channel control unit in the order of the character strings describing the channels in response to said switching request signal, and the character string describing the channel as switched is displayed by said channel display unit,
wherein, when said skip request signal is acquired, the channel is successively switched and displayed by said channel display unit in accordance with the character strings describing the groups.

2. The channel switching device as claimed in claim 1 wherein said skip request signal is the switching request signal which is continuously acquired for a predetermined period or longer.

3. The channel switching device as claimed in claim 1 wherein, in the case where the acquisition of said skip request signal is halted when the character string describing said group is being displayed, said channel control unit changes over to the channel representing the group which is displayed.

4. The channel switching device as claimed in claim 1 wherein, in the case where the acquisition of said skip request signal is halted when the character string describing said group is being displayed, if the switching request signal is acquired within a predetermined period after halting the acquisition said channel control unit successively switches among the channels belonging to the group, which is displayed, in the order of the character strings describing the channels.

5. The channel switching device as claimed in claim 1 wherein said channel display unit displays the content of the channel which is switched or the content relating to the group which is switched.

6. A channel switching method for a content receiver which is provided with a content acquisition unit operable to receive content, or to read content from a content accumulation unit which accumulates the content as received, said method comprising:
a step (1) of acquiring a switching request signal and a skip request signal on the basis of user's manipulation; and
a step (2) of switching among the channels which specify the content to be received or read by said content acquisition unit in response to said switching request signal, wherein in said step (2)
the channel is switched in the order of the character strings describing the channels in response to said switching request signal, and the character string describing the channel as switched is displayed, and
when said skip request signal is acquired, the channel is successively switched in the order of character strings describing groups on the basis of attribute information associated with said content or said channels.

7. The channel switching device as claimed in claim 1 wherein said skip request signal is the switching request signal which is continuously acquired for a predetermined period or longer.
